(19) United States
(12) Patent Application Publication
(10) Pub. No.: US 2026/0095774 A1
(43) Pub. Date: Apr. 2, 2026

(54) FUTURE SITE CAPACITY CALCULATIONS AND NETWORK MANAGEMENT

(71) Applicant: T-Mobile USA, Inc., Bellevue, WA (US)

(72) Inventor: SM Sohelozzaman, Pittsburg, CA (US)

(21) Appl. No.: 18/900,347

(22) Filed: Sep. 27, 2024

(51) Int. Cl. H04W 16/18; H04W 24/08

(52) U.S. Cl. CPC H04W 16/18; H04W 24/08

(57) ABSTRACT

Techniques, devices, and systems for predicting and/or mitigating geographic and temporal-specific user equipment (UE) population surge-related network service problems. For example, service provider servers can be utilized to prevent decreases in the downlink speeds by calculating parameters associated with predicted UEs at future events. The parameters can include expected downlink speeds utilized to manage, modify, add, etc., cell sites at geographic locations associated with the future events.

### BACKGROUND

Cellular communications systems may use a variety of transceivers to connect cellular phones to a cellular network (or, “backbone”, which often refers specifically to the aggregated backhaul portion of a cellular network). These can include macro cells (or, cell towers), mini- and micro-cells, and even wireless routers. For example, for instances with the cell towers being used to connect the calls, the cell towers may provide the ability to connect any number of cellular calls (e.g., fourth generation (4G) network-based calls, fifth generation (5G) network-based calls, etc., or any combination thereof) and/or any number of cellular data connections at the same time.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 schematically illustrates an example environment for potential radio resource connected (RRC) user equipment (UE) population-based and predicted available spectrum-based future site capacity calculations and network management, according to implementations of the present disclosure.

FIG. 2 schematically illustrates an example environment for potential RRC UE population-based and predicted available spectrum-based future site capacity calculations and network management, for a network with various types of cell sites, including non-standalone access (NSA) capable cell sites.

FIG. 3 is a diagram illustrating an example graph representing a relationship between radio resource connected users (RRCUs) and downlink speeds.

FIG. 4 illustrates an example process for potential RRC UE population-based and predicted available spectrum-based future site capacity calculations.

FIG. 5 illustrates is a block diagram of a server computer 500 architecture, in accordance with some examples of the present disclosure.

### DETAILED DESCRIPTION

Techniques described herein are directed to predicting and/or mitigating geographic and temporal-specific UE population surge-related network service problems. For example, a wireless network may include various types of devices such as base stations (BS) in communication currently with UEs, and potentially in the future with greater numbers of UEs. Because unexpected, unpredicted, or unaccounted for increases in numbers of UEs connected to BSs may result in decreases in bandwidths associated with data communicated between the UEs and the BSs, downlink speeds experienced by the UEs may decrease. In some examples, service provider servers can be utilized to prevent the decreases in the downlink speeds by calculating parameters associated with cell sites and predicted UEs at locations during future events. The parameters can include average expected downlink speeds utilized to manage, modify, add, etc., cell sites at geographic locations associated with the future events.

In various implementations, the average expected downlink speeds can be identified by analyzing parameters associated with different types of telecommunication networks with which the cell sites at the geographic locations are compatible. The parameters associated with the telecommunication networks can include various frequency bands, different available bandwidths, different factors, and effective bandwidths. The available bandwidths and the factors can be identified based on the frequency bands. The effective bandwidths can be identified by analyzing the available bandwidths and the factors.

Accordingly, the techniques, devices, and systems described herein improve the service quality of telecommunication networks, including 5G networks, 4G networks (long term evolution-advanced (LTE-A) networks, long term evolution (LTE) networks, etc.), and/or networks of other kinds. UEs connected to existing networks at geographic locations, and at times, associated with events may experience slow network speeds, dropped calls, service interruptions, and so on, or any combination thereof. In contrast, networks operating utilizing the current techniques moderate and/or increase network speeds, reduce numbers of dropped calls, reduce occurrences of service interruptions, and so on, or any combination thereof, for UEs connected to the networks at geographic locations, and at times, associated with events.

By utilizing the techniques discussed herein, networks enable placement and/or activation of sufficient numbers, and types, of cell sites for cellular services utilized by UEs. The networks enable levels of cellular services utilized by UEs during times, and at locations, of the events to be available that are within threshold levels of cellular services available to UEs at the locations of the events during other times. Overall operating efficiencies of the networks are improved by optimized placement of cell sites with respect to events taking place at geographic locations at scheduled and/or predicted times.

In contrast to relatively error-prone existing networks which do not have efficient and effective placement of cell sites, networks that utilize potential RRC user equipment UE population-based and predicted available spectrum-based future site capacity calculations and network management are able to conserve resources of various types. The networks operating according to the techniques discussed herein have cell sites of appropriate types, numbers, spacing, and so on, placed at geographic locations at scheduled or predicted times, thereby conserving network resources. The network resources are conserved as a result of the networks undergoing fewer incomplete communications, service interruptions, etc., or any combination thereof.

The networks operating according to the techniques discussed herein have cell sites of appropriate types, numbers, spacing, and so on, at geographic locations at scheduled or predicted times. By including the appropriate cell sites, the networks conserve compute resources of servers utilized to manage the networks, and compute resources of cellular devices, such as the UEs. The compute resources are conserved as a result of the UEs being able to more efficiently and reliably connect to the networks and utilize services of the networks.

The networks operating according to the techniques discussed herein conserve memory resources of the servers utilized to manage the networks, and memory resources of the cellular devices, such as the UEs. The memory resources are conserved as a result of the servers and the UEs experiencing fewer service interruptions and dropped calls. The fewer service interruptions and dropped calls avoid necessities of the servers and the UEs to retain data after occurrences of service interruptions and dropped calls so that the data is available to reattempt service operations and/or to replace calls.

In general, the techniques discussed herein may be implemented in any multi connectivity environment, which is not limited to a 5G environment, a 4G environment, a third generation (3G) environment, a second generation (2G) environment, any other type of environment, or any combination thereof. In some examples, an NR base station can be considered a primary base station, an LTE base station can be considered a secondary base station, and vice versa. In some instances, a core network can be represented as a 5G core network, a 4G core network, any other type of core network, or any combination thereof. In some instances, the techniques can be implemented in standalone implementations (e.g., Option 1 and/or 2, as referred to by 3GPP) or in non-standalone implementations such as those referred to as Option 3, 4, 7, etc. by 3GPP. In some examples, the techniques discussed herein may be implemented outside a dual connectivity environment involving a single base station or network access technology and multiple bearers.

The systems, devices, and techniques described herein can be implemented in a number of ways. References are made to the accompanying drawings that form a part hereof, and in which are shown by way of illustration specific configurations or examples, in which like numerals represent like elements throughout the several figures.

### Illustrative Systems for Future Site Capacity Calculations and Network Management

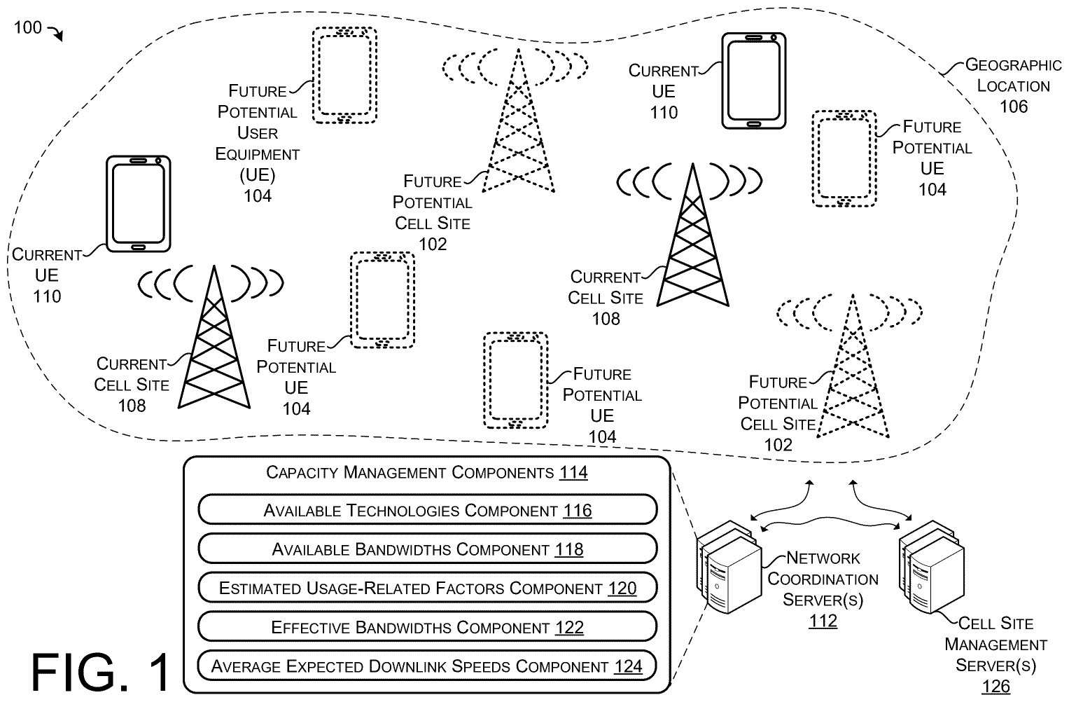

FIG. 1 schematically illustrates an example environment 100 for potential RRC UE population-based and predicted available spectrum-based future site capacity calculations and network management, according to implementations of the present disclosure. The environment 100 can include one or more future potential cell sites 102 and one or more future potential UEs 104, represented as being associated with a future time by dotted lines as illustrated in FIG. 1. The future potential cell site(s) 102 and future potential UE(s) 104 can be identified based on a geographic location (also referred to herein simply as “site”) 106 at which a future event is scheduled. The environment 100 can include one or more current cell sites 108 and one or more current UEs 110 (e.g., at the geographic location 106), represented as being associated with a current time by solid lines as illustrated in FIG. 1.

The terms “user equipment (UE),” “user device,” “wireless communication device,” “wireless device,” “communication device,” “mobile device,” and “client device,” can be used interchangeably to describe any UE (e.g., any of the future potential UE(s) 104, any of the current UE(s) 110, etc.) that is capable of transmitting/receiving data wirelessly using any suitable wireless communications/data technology, protocol, or standard, such as Global System for Mobile communications (GSM), Time Division Multiple Access (TDMA), Universal Mobile Telecommunications System (UMTS), Evolution-Data Optimized (EVDO), Long Term Evolution (LTE), Advanced LTE (LTE+), New Radio (NR), Generic Access Network (GAN), Unlicensed Mobile Access (UMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), High Speed Packet Access (HSPA), evolved HSPA (HSPA+), Voice over IP (VoIP), VoLTE, Institute of Electrical and Electronics Engineers' (IEEE) 802.1x protocols, WiMAX, Wi-Fi, Data Over Cable Service Interface Specification (DOCSIS), digital subscriber line (DSL), CBRS, and/or any future Internet Protocol (IP)-based network technology or evolution of an existing IP-based network technology.

Examples of UEs (e.g., the future potential UE(s) 104 and/or the current UE(s) 110) can include, but are not limited to, smart phones, mobile phones, cell phones, tablet computers, portable computers, laptop computers, personal digital assistants (PDAs), electronic book devices, or any other portable electronic devices that can generate, request, receive, transmit, or exchange voice, video, and/or digital data over a network. Additional examples of UEs include, but are not limited to, smart devices such as televisions, refrigerators, washing machines, dryers, smart mirrors, coffee machines, lights, lamps, temperature sensors, leak sensors, water sensors, electricity meters, parking sensors, music players, headphones, or any other electronic appliances that can generate, request, receive, transmit, or exchange voice, video, and/or digital data over the network.

The future potential cell site(s) 102 may be utilized to operate the network to which the future potential UE(s) 104 are communicatively connected during the future event. The current cell site(s) 108 may be utilized at a current time to operate the network to which the current UE(s) 110 are communicatively connected. The network can include one or more networks, such as a 5G network, a 4G network, a 3G network, any number of other types of networks, or any combination thereof.

The network to which the future potential UE(s) 104 are communicatively connected during the future event may be the same as the network to which the current UE(s) 110 are communicatively connected. However, the disclosure is not limited as such, and the network as discussed herein may represent any network and/or combination of networks. For example, the network, for purposes of implementing any of the techniques as discussed herein, may represent the network to which the future potential UE(s) 104 are communicatively connected during the future event, and/or a different network to which the current UE(s) 110 are communicatively connected.

One or more base stations, such as, for example, the future potential cell site(s) 102 and/or the current cell site(s) 108, may be capable of transmitting and/or receiving data wirelessly using one or more radio technologies. As used herein, the term “radio technology” can refer to a type, technique, specification, or protocol by which data is transmitted wirelessly. In some cases, a radio technology can specify which frequency bands are utilized to transmit data. For instance, a “5G radio technology” can refer to the NR standard, as defined by 3GPP. In some cases, a “4G radio technology” can refer to the LTE radio standard, as defined by 3GPP.

In particular examples, any of the future potential cell site(s) 102 and/or any of the current cell site(s) 108 can utilize a 5G radio technology, a 4G radio technology, a 3G radio technology, etc., or any combination thereof. In some instances, any of the future potential cell site(s) 102 and/or any of the current cell site(s) 108 can also utilize the 5G radio technology, such as technology specified in the 5G NR standard, as defined by 3GPP. In certain implementations, any of the future potential cell site(s) 102 and/or any of the current cell site(s) 108 can transmit and receive communications with devices (e.g., any of the future potential UE(s) 104 and/or any of the current UE(s) 110) over to a connection (e.g., at least one NR radio link) that is defined according to frequency resources including but not limited to 5G Band 1 (e.g., 2080 MHz), 5G Band 2 (1900 MHz), 5G Band 3 (1800 MHz), 5G Band 4 (1700 MHz), 5G Band 5 (850 MHz), 5G Band 7 (2600 MHz), 5G Band 8 (900 MHz), 5G Band 20 (800 MHz), 5G Band 28 (700 MHz), 5G Band 38 (2600 MHz), 5G Band 41 (2500 MHz), NR Band 48 (e.g., 3500 MHz), 5G Band 50 (1500 MHz), 5G Band 51 (1500 MHz), 5G Band 66 (1700 MHz), 5G Band 70 (2000 MHz), 5G Band 71 (e.g., a 600 MHz band), 5G Band 74 (1500 MHz), 5G Band 257 (28 GHz), 5G Band 258 (24 GHZ), 5G Band 260 (39 GHz), 5G Band 261 (28 GHz), and the like. In some embodiments, any number of the base station(s) can be, or at least include, a gNodeB.

In some instances, any of the future potential cell site(s) 102 and/or any of the current cell site(s) 108 can also utilize the 4G radio technology, and transmit and receive data via one more connections (e.g., at least one LTE radio link) that is defined according to frequency bands included in, but not limited to, a range of 450 MHz to 5.9 GHZ. In various examples, one or more frequency bands associated with the service provider may be associated with any of one or more contracts (e.g., any of one or more leases), any of one or more agreements, and/or any of one or more transactions (e.g., any of one or more purchase transactions), etc., of the service provider for the frequency band(s) and/or for any available bandwidths (e.g., the available bandwidth(s), as discussed below, in further detail).

For instance, the frequency band(s) may be identified by (e.g., via one or more identifiers received from) any number of one or more service provider servers associated with the service provider, any number of one or more network servers associated with the network, any number of one or more other servers associated with the service provider and the network, and/or any combination thereof. The frequency band(s) may be identified at one or more of various times, such as prior to any of the request(s), prior to all of the request(s), after and/or coinciding with any of the request(s), etc. The frequency band(s) may include the frequency bands utilized by any of the base station(s).

In some instances, the frequency bands utilized for any number of the base station(s) can include, but are not limited to, LTE Band 1 (e.g., 2100 MHz), LTE Band 2 (1900 MHz), LTE Band 3 (1800 MHz), LTE Band 4 (1700 MHz), LTE Band 5 (850 MHz), LTE Band 7 (2600 MHz), LTE Band 8 (900 MHz), LTE Band 20 (800 MHz GHz), LTE Band 28 (700 MHz), LTE Band 38 (2600 MHz), LTE Band 41 (2500 MHz), LTE band 48 (e.g., 3500 MHz), LTE Band 50 (1500 MHz), LTE Band 51 (1500 MHz), LTE Band 66 (1700 MHz), LTE Band 70 (2000 MHz), LTE Band 71 (e.g., a 600 MHz band), LTE Band 74 (1500 MHz), and the like. In some examples, the base station(s) (e.g., the future potential cell site(s) 102 and/or the current cell site(s) 108) can be, or at least include, an eNodeB.

The future potential cell site(s) 102, the future potential UE(s) 104, the current cell site(s) 108, and/or the current UE(s) 110 may be capable of supporting 5G radio communications, such as New Radio (NR) communications, 4G radio communications, such as LTE radio communications, and/or other types of radio communications. In some examples, any of the future potential cell site(s) 102, any of the future potential UE(s) 104, any of the current cell site(s) 108, and/or any of the current UE(s) 110 may be configured to support at least one of enhanced Mobile Broadband (eMBB) communications, Ultra Reliable Low Latency Communications (URLLCs), or massive Machine Type Communications (mMTCs). In some instances, the one or more devices can include at least one device supporting one or more of a sensor network, voice services, smart city cameras, gigabytes-in-a-second communications, 3D video, 4K screens, work & play in the cloud, augmented reality, industrial and/or vehicular automation, mission critical broadband, or self-driving cars.

In some examples, a total number of all of the future potential cell site(s) 102 (e.g., at the geographic location 106) may be identified based on the future potential cell site(s) 102 and the current cell site(s) 108. For instance, the future potential cell site(s) 102 may include the current cell site(s) 108 and/or one or more different cell sites to be placed at the geographic location 106 during the future event. In those or other examples, a total number of all of the current cell site(s) 108 (e.g., at the geographic location 106) may be identified based on the current cell site(s) 108, but without taking into account the different cell site(s) to be placed at the geographic location 106 during the future event.

In various embodiments, the total number of all of the future potential cell site(s) 102 (e.g., at the geographic location 106) and a total number of all of the current cell site(s) 108 (e.g., at the geographic location 106) may be different. In some examples, any of at least one of the future potential cell site(s) 102 can include any of at least one of the current cell site(s) 108, and/or vice versal.

In various embodiments, the total number of all of the future potential UE(s) 104 (e.g., at the geographic location 106) and a total number of all of the current UE(s) 110 (e.g., at the geographic location 106) may be different. In those or other examples, any of at least one of the future potential UE(s) 104 can include any of at least one of the current UE(s) 110, and/or vice versa.

The environment 100 can include any number of the servers(s) (e.g., one or more network coordination servers 112) associated with the service provider and/or the network, and utilized for coordination (e.g., of the request(s), as discussed below, in further detail). The network coordination server(s) 112 can be utilized to perform one or more potential RRC UE population-based and predicted available spectrum-based future site capacity calculations (also referred to herein simply as “calculation(s)”). The calculation(s) can be performed to determine information associated with the future potential cell site(s) 102 and/or the future potential UE(s) 104. The network coordination server(s) 112 can be associated with, and/or operated by a service provider.

The network coordination server(s) 112 can include capacity management components 114. The capacity management components 114 can include an available technologies component 116, an available bandwidths component 118, an estimated usage-related factors component 120, an effective bandwidths component 122, and an expected downlink speeds component (e.g., an average expected downlink speeds component) 124. One or more of the capacity management components 114, including the available technologies component 116, the available bandwidths component 118, the estimated usage-related factors component 120, the effective bandwidths component 122, the average expected downlink speeds component 124, or any combination thereof, can be utilized to perform any of at least one of the calculation(s).

Individual ones of the available technologies component 116, the available bandwidths component 118, the estimated usage-related factors component 120, the effective bandwidths component 122, and/or the average expected downlink speeds component 124 can be utilized to identify one or more parameters, via the calculation(s). The parameter(s) may be one or more predicted and/or calculated parameters associated with a geographic location 106 during a future event.

The parameter(s) can include, for example, one or more frequency bands, one or more available bandwidths (or “available BW(s)”) associated with the frequency band(s), one or more estimated usage-related factors (or “multi factor(s)”) associated with the frequency band(s), one or more effective bandwidths (or “effective BW(s)”) associated with the frequency band(s), one or more other parameters, or any combination thereof. Additionally or alternatively, the parameter(s) can include one or more expected downlink speeds (e.g., one or more average expected downlink speeds), which can be identified based on the parameter(s) (e.g., the frequency band(s), the available bandwidth(s), the estimated usage-related factor(s), the effective bandwidth(s), the other parameter(s), or any combination thereof.

For instance, the estimated usage-related factor(s) may be identified by (e.g., via one or more identifiers received from) any number of the server(s) associated with the service provider and/or the network. The estimated usage-related factor(s) may be identified at one or more of various times, such as prior to any of the request(s), prior to all of the request(s), after and/or coinciding with any of the request(s), etc.

The available technologies component (or “available frequency bands component”) 116 can be utilized to manage one or more technologies, such as the frequency band(s), based on the frequency band(s) being identified as being available at a portion of the network. The portion of the network, for example, may be available and/or accessible at the geographic location 106. For example, the available technologies component 116 can be utilized to manage the frequency band(s), based on the frequency band(s) being identified as being available at one or more geographic locations associated with one or more future events. The geographic location(s) may include the geographic location 106 at which the portion of the network is available and/or accessible (e.g., to the future potential UE(s) 104) during the future event (e.g., from among the future event(s)). The frequency band(s) may be one or more predicted frequency bands available and/or accessible at the geographic location 106 during the future event.

In some examples, individual ones of the frequency band(s) can be identified as a frequency band predicted as being associated with one or more cellular cites at the geographic location 106 during the future event. For instance, the frequency band can be identified as one of the frequency band(s) based on the frequency band being predicted as being associated with the future potential cell site(s) 102.

The available bandwidths component 118 can be utilized to manage the available bandwidth(s) associated with the frequency band(s). For example, the available bandwidths component 118 can be utilized to manage the available bandwidth(s), based on individual ones of the available bandwidth(s) being identified as being associated with corresponding frequency bands from among the frequency band(s). The available bandwidth(s) may be one or more representative values corresponding to, respectively, one or more relative amounts of the available bandwidth(s) predicted to be available at the geographic location 106 during the future event.

For instance, an available bandwidth may be a value representing a relative amount of the available bandwidth predicted to be available for a corresponding frequency band at the geographic location 106 during the future event. In some examples, an available bandwidth (e.g., 10 Mhz) may be utilized to represent a value (e.g., 10 MHz) as an available bandwidth that is predicted to be available for a frequency band (e.g., an N1900 frequency band) at the geographic location 106 during the future event. In those or other examples, an available bandwidth (e.g., 400 MHz) associated with a frequency band (e.g., an N39 frequency band) may be equal to or larger than an available bandwidth (e.g., 120 MHz) associated with a frequency band (e.g., an N2500 (or “N25”) frequency band), which may be equal to or larger than an available bandwidth (e.g., 20 MHz) associated with a frequency band (e.g., an L21 frequency band), which may be equal to or larger than an available bandwidth (e.g., 20 MHz) associated with a frequency band (e.g., an L19 frequency band), which may be equal to or larger than an available bandwidth (e.g., 10 MHz) associated with a frequency band (e.g., an N1900 (or “N19”) frequency band), etc.

In various examples, the available bandwidth(s) may include bandwidth(s) (e.g., one or more identifiers of the bandwidth(s)) associated with the service provider. For instance, the available bandwidth(s) may be identified by (e.g., via one or more identifiers received from) any number of the server(s) associated with the service provider and/or the network. The available bandwidth(s) may be identified at one or more of various times, such as prior to any of the request(s), prior to all of the request(s), after and/or coinciding with any of the request(s), etc. In some instances, the available bandwidth(s) may be associated with any of the contract(s), any of the agreement(s), any of the transaction(s), etc., of the service provider, such as for the bandwidth(s).

The estimated usage-related factors component 120 can be utilized to manage the estimated usage-related factor(s) associated with the frequency band(s). For example, the estimated usage-related factors component 120 can be utilized to manage the estimated usage-related factor(s), based on individual ones of the estimated usage-related factor(s) being identified as being associated with corresponding frequency bands from among the frequency band(s). The estimated usage-related factor(s) may be one or more representative values corresponding to, respectively, one or more relative amounts of the available bandwidth(s) predicted to be used at the geographic location 106 during the future event.

In some examples, individual ones of the estimated usage-related factor(s) may correspond to an amount of a frequency band that the service provider decides should be utilized for a corresponding number of the UEs (e.g., the current UE(s) 110, the future potential UE(s) 104, etc., or any combination thereof). For instance, the estimated usage-related factor(s) may represent relative amounts of the corresponding frequency band(s) that the service provider wants and/or desires to be utilized by the UEs. By identifying (e.g., setting) an estimated usage-related factor (e.g., 0.8) to be relatively higher for a frequency band (e.g., an N2500 frequency band), the service provider may identify and/or establish a relatively larger amount of the frequency band, and/or a relatively larger number of UEs to access, and/or to be predicted to access, that frequency band, in comparison to another estimated usage-related factor (e.g., 0.5) identified (e.g., set) to be relatively lower for another frequency band (e.g., an N1900 frequency band).

In some cases, the estimated usage-related factor(s) may be algorithmically defined utilizing the server(s) associated with the service provider and/or the network. The estimated usage-related factor(s) may be geographically specific (e.g., specific to a corresponding geographic location (e.g., the geographic location 106), specific to a frequency band, specific to a service provider, specific to network management criteria, specific to any other criteria, or any combination thereof.

For instance, an estimated usage-related factor may be a value representing a relative amount of a corresponding available bandwidth predicted to be used for a corresponding frequency band at the geographic location 106 during the future event. In some cases, an estimated usage-related factor (e.g., 0.5) is utilized to represent half of an entire amount of an available bandwidth that is predicted to be used for a frequency band at the geographic location 106 during the future event.

The effective bandwidths component 122 can be utilized to manage the effective bandwidth(s), associated with the frequency band(s). For example, the effective bandwidths component 122 can be utilized to manage the effective bandwidth(s), based on individual ones of the effective bandwidth(s), being identified as being associated with corresponding frequency band(s) from among the frequency band(s).

In various examples, the effective bandwidths component 122 can identify the effective bandwidth(s) based on the frequency band(s), the available bandwidth(s), and the estimated usage-related factor(s). In those or other examples, individual ones of the effective bandwidth(s) can be calculated by multiplying a corresponding available bandwidth associated with a frequency band by a corresponding estimated usage-related factor associated with a frequency band. For instance, an effective bandwidth (e.g., 5 Mhz) can be calculated by multiplying a corresponding available bandwidth (e.g., 10 MHz) associated with a frequency band by a corresponding estimated usage-related factor (e.g., 0.5) associated with a frequency band.

A group of any of the bandwidths (e.g., the available bandwidth(s), the effective bandwidth(s), etc.) can be utilized to identify one or more total bandwidths, corresponding thereto. In some examples, the other parameter(s) can include the total bandwidth(s), which can include one or more total available bandwidths. The total available bandwidth(s) can include a total available bandwidth based on the available bandwidth(s). The total available bandwidth may be a predicted total available bandwidth at the geographic location 106 during the future event. In some instances, the total available bandwidth can be calculated by adding together all of the available bandwidth(s) identified based on the frequency band(s).

In those or other examples, the total bandwidth(s) can include one or more total effective bandwidths. The total effective bandwidth(s) can include a total effective bandwidth based on the effective bandwidth(s). The total effective bandwidth may be a predicted total effective bandwidth at the geographic location 106 during the future event. In some instances, the total effective bandwidth can be calculated by adding together all of the effective bandwidth(s) identified based on the frequency band(s).

In some examples, any of the parameter(s) may be associated with the geographic location 106 at a time (e.g., an instant of time, a period of time, etc., or any combination thereof) associated with the future event. For instance, the parameter(s) can include frequency bands, available bandwidths, a total available bandwidth, estimated usage-related factors (or “factors”), effective bandwidths, and a total effective bandwidth, in example table 1, shown below.

(1)

| | Frequency | Available | | Effective |
|---|---|---|---|---|
| | Bands | Bandwidths | Factors | Bandwidths |
| | F₁ | X₁ | Y₁ | Z₁ |
| | F₂ | X₂ | Y₂ | Z₂ |
| | F₃ | X₃ | Y₃ | Z₃ |
| | F₄ | X₄ | Y₄ | Z₄ |
| | F₅ | X₅ | Y₅ | Z₅ |
| | F₆ | X₆ | Y₆ | Z₆ |
| | F₇ | X₇ | Y₇ | Z₇ |
| | F₈ | X₈ | Y₈ | Z₈ |
| Total | | XX | | ZZ |
| Bandwidths | | | | |

In various examples, the frequency bands (e.g., F₁-F₈) include an LTE 600 megahertz (MHz) frequency band (e.g., an L6 frequency band), an LTE 700 MHz frequency band (e.g., an L7 frequency band), an LTE 2100 MHz frequency band (e.g., an L21 frequency band), an LTE 1900 MHz frequency band (e.g., an L19 frequency band), a 5G 1900 MHz frequency band (e.g., an N1900 frequency band), a 5G 2500 MHz frequency band (e.g., an N2500 frequency band), a 5G 39 gigahertz (GHz) frequency band (e.g., an N39 frequency band), and a 5G 77 GHz frequency band (e.g., an N77 frequency band). However, the disclosure is not limited as such; and the frequency bands may include any number of any types of frequency bands associated with the geographic location 106 during the future event.

The capacity management components 114 can include one or more other components utilized, individually or in combination, to manage any of at least one of the other parameter(s). In some examples, the other parameter(s) can include a total number of UEs parameter (also simply referred to herein as “total number of UEs”). For example, the total number of UEs may be a total number of predicted UEs, which may include a total number of related UEs (e.g., UEs related to a service provider with which the network coordination server(s) 112 and/or the network are associated) predicted to be at the geographic location 106 during the future event, and a total number of unrelated UEs (e.g., UEs unrelated to the service provider and/or the network) predicted to be at the geographic location 106 during the future event.

In some examples, the other parameter(s) can include an expected simultaneous users parameter. For instance, the expected simultaneous users parameter may be a total number of related expected RRCUs, such as the future potential UE(s) 104, which may be predicted to be associated with the service provider and which may be predicted to be RRC UEs (e.g., as simultaneous users) at the geographic location 106 during the future event. The expected simultaneous users parameter may be identified based on a percentage of the total number of predicted UEs (e.g., all predicted related and predicted unrelated UEs associated with the geographic location 106 during the future event). For example, the predicted UEs may include one or more related UEs (e.g., the future potential UEs 104) associated with a service provider, and one or more unrelated UEs associated with one or more other service providers.

In some instances, the expected simultaneous users parameter may be a total number of the future potential UEs 104 as determined by multiplying the total number of the related and unrelated UEs (e.g., the future potential UEs 104 and the predicted unrelated UE(s)) by a multiplier that represents a percentage (e.g., 30%, 40%, 50%) of the total number of the related and unrelated UE(s) (e.g., the future potential UEs 104 and the unrelated UE(s)) predicted to be RRC UEs, and by a multiplier that represents a percentage (e.g., 30%, 40%, 50%) of the total number of the related and unrelated UE(s) (e.g., the future potential UEs 104 and the unrelated UE(s)) predicted to be associated with the service provider. For example, the expected simultaneous users parameter (e.g., 450 RRC UEs) may be calculated by multiplying a total number (e.g., 5000) of the related and unrelated UE(s) by a percentage (e.g., 30%) of the total number of the related and unrelated UE(s) (e.g., the future potential UEs 104 and the unrelated UE(s)) predicted to be RRC UEs and by a percentage (e.g., 30%) of the total number of the related and unrelated UE(s) predicted to be associated with the service provider.

In some examples, the other parameter(s) can include an expected reference signal received power (RSRP) improvement parameter (also simply referred to herein as “expected RSRP improvement” or “RSRP improvement”), such as with respect to a distance range associated with the geographic location 106. The distance range with respect to the geographic location 106 may include, for instance, a range between the geographic location 106 (e.g., 0 meters) and a predetermined distance (e.g., 500 meters (m), 1 kilometer (km), 5 km, etc.) from the geographic location 106. For instance, an expected RSRP improvement (e.g., −84 to −100 decibel-milliwatts (dBm)) can be identified between a distance (or “first distance”) (e.g., 0 meters) from the geographic location 106 and a distance (or “second distance”) (e.g., 500 m) from the geographic location 106.

In some examples, the expected RSRP improvement may be a signal strength improvement (e.g., a measurement of improvement of the signal strength) determined empirically by the service provider, the server(s) (e.g., associated with the service provider and/or the network), and/or one or more personnel (e.g., out in the field, such as at and/or near the geographic location 106) of the service provider. For instance, an RSRP (e.g., −84 dBm) may be a level of RSRP at 0 meters from the geographic location 106 and/or an RSRP (e.g., −100 dBm) may be a level of RSRP at 500 m from the geographic location 106. In some cases, any of the RSRP values (e.g., and/or the expected RSRP improvement) may be identified (e.g., automatically identified and/or updated, in real-time, periodically, on an ongoing and/or continuing basis, etc., or any combination thereof) based on data (e.g., location(s) and/or RSRP measurement(s)) received from the current UE(s) 110.

The average expected downlink speeds component 124 can be utilized to manage the average expected downlink speed(s), such as an expected downlink speed (e.g., an average expected downlink speed). The average expected downlink speed may be a predicted average expected downlink speed at the geographic location 106 during the future event. In various instances, the average expected downlink speed may be a predicted average expected downlink speed for the future potential UE(s) 104 at the geographic location 106 during the future event.

In some examples, the predicted average expected downlink speed can be identified based on an RRC per 5 MHz parameter identified a result of analyzing the expected simultaneous users parameter, the expected RSRP improvement, the frequency band(s), the available bandwidth(s), and the estimated usage-related factor(s), and the effective bandwidth(s). In various examples, the RRC per 5 MHz parameter may represent a total number of the future potential UEs 104 predicted to be RRC UEs (e.g., UEs simultaneously connected to the network via the future potential cell site(s) 102) per an amount of bandwidth (e.g., 5 MHz), at the geographic location 106 during the future event. For instance, an RRC per 5 MHz parameter (8.62069 RRCUs/5 MHz, or 8.62069 “RRC/5 MHz”) may be identified a result of analyzing the expected simultaneous users parameter, the expected RSRP improvement, the frequency band(s), the available bandwidth(s), and the estimated usage-related factor(s), and the effective bandwidth(s).

For example, the RRC/5 MHz parameter may be determined, such as based on a geographic area. UE(s) (e.g., the current UE(s) 110) may receive one or more broadcasts (e.g., one or more periodic, reoccurring, etc., broadcasts) from a network tower (e.g., a current cell site 108). Individual ones of the UE(s) 110, which may be in an idle mode (e.g., a mode during which the UE is not accessing data by browsing, downloading, streaming, being utilized for a call, utilizing any other radio resources, etc.), may reply with an identifier that the UE is receiving the broadcast(s). Any of the UE(s) that uses, and/or begins using, a radio resource, such as with the UE making a call, exchanging messages, streaming media, etc., may be identified as an RRCU.

In various examples, the average expected downlink speed can be managed (e.g., identified, determined, generated, modified, deleted, etc., or any combination thereof) utilizing the expected simultaneous users parameter, the expected RSRP improvement, the frequency band(s), the available bandwidth(s), the total available bandwidth, the estimated usage-related factor(s), the effective bandwidth(s), the total effective bandwidth, and/or the RRC per 5 MHz parameter. In some examples, the predicted average expected downlink speed can be identified in response to performing the calculation(s) (e.g., utilizing with the parameter(s)). In some examples, the predicted average expected downlink speed can be identified as one or more corresponding result of the calculation(s).

For instance, the average expected downlink speed (e.g., 50-75 megabit per second (Mbps), or any other value) can be identified utilizing the expected simultaneous users parameter (e.g., 450 RRC UEs, or any other value), the expected RSRP improvement (e.g., −84 to −100 dBm, or any other value), the total available bandwidth (e.g., 570 MHz, or any other value) (e.g., based on the available bandwidth(s) associated with the frequency band(s), respectively), the total effective bandwidth (e.g., 261, or any other value) (e.g., based on the effective bandwidth(s) associated with the frequency band(s), respectively, and which can be identified using the available bandwidth(s) and the estimated usage-related factor(s)), and the RRC per 5 MHz parameter (e.g., 8.62069 RRCUs/5 MHz, or any other value).

While the frequency band(s) may be the predicted frequency band(s) available and/or accessible at the geographic location 106 during the future event, as discussed above in the current disclosure, it is not limited as such. In some examples, the frequency band(s) may include a frequency band being selected (e.g., and/or predetermined) based on the frequency band being associated with a first primary carrier in the geographic location 106. For instance, a frequency band (e.g., an N39 frequency band) may be utilized (e.g., established) as an initial frequency band (e.g., and/or a corresponding frequency (or “a primary frequency”)) for any UE. For example, the UE being turned on and/or searching for an initial frequency band, based upon the UE identifying a carrier to be utilized by the UE, may identify the initial frequency band.

In those or other examples, the frequency band(s) may include at least one frequency band being selected (e.g., and/or predetermined) based on the at least one frequency band being associated with a carrier priority setting (e.g., setting with one or more priorities). Individual ones of the at least one frequency band being associated with the carrier priority setting may have corresponding priorities. For instance, the at least one frequency band associated with the carrier priority setting may include the 5G 39 GHz band with a priority (e.g., a first priority from among the priority(ies)). In such an instance or another instance, the at least one frequency band associated with the carrier priority setting may include the 5G 2500 MHz band with a priority (e.g., a second priority from among the priority(ies)) lower than the first priority.

In such an instance or another instance, the at least one frequency band associated with the carrier priority setting may include the LTE 2100 MHz band with a priority (e.g., a third priority from among the priority(ies)) lower than the second priority. In such an instance or another instance, the at least one frequency band associated with the carrier priority setting may include the LTE 1900 MHz band with a priority (e.g., a fourth priority from among the priority(ies)) lower than the third priority. In such an instance or another instance, the at least one frequency band associated with the carrier priority setting may include the 5G 19 GHz band with a priority (e.g., a fifth priority from among the priority(ies)) lower than the fourth priority.

In some instances, the frequency band(s) may be identified (e.g., and/or predetermined) based on the 5G 2500 MHz band being selected to be utilized for data communication. In those or other instances, the data communication may be performed utilizing only the 5G 2500 MHz band, with none of the other frequency band(s) being utilized for data communication.

In some examples, for instance with only the 5G 2500 MHz band being utilized for the data communication, the 5G 2500 MHz band may be utilized for a throughput calculation. For instance, the throughput calculation may be a predicted throughput calculation associated with an individual UE or group of UEs (e.g., a group of some or all of the UEs) of the future potential UE(s) 104 connected to the network at the geographic location 106.

However, while the data communication and throughput calculation may be performed utilizing only the 5G 2500 MHz band, as discussed above in the current disclosure, it is not limited as such. In some examples, the data communication and the throughput calculation may be performed utilizing the 5G 2500 MHz band and at least one of the remaining frequency band(s) (e.g., at least one other frequency band from among the frequency band(s)).

In some examples, the environment 100 can include any number of the server(s) (e.g., one or more cell site management servers (or “network management server(s)”) 126) associated with the service provider and/or the network, and utilized for management of the action(s) (e.g., the action(s) as discussed below, in further detail). In some examples, the cell site management servers 126 are communicatively connected to the current cell site(s) 108, the current UE(s) 110, the network coordination server(s) 112, one or more other computing devices and/or other devices associated with the network, or any combination thereof. The cell site management servers 126 can be associated with, and/or operated by the service provider.

Any of at least one of the computing devices may include an operator device associated with an operator, a user device associated with a user, a remote device (e.g., a device being remote to the network, being indirectly connected to the network, and/or being connected to the network via one or more other networks), a local device (e.g., a device being local to the network and being directly connected to the network), and so on, or any combination thereof. Any of at least one of the computing devices may be a personal computer (PC), laptop, tablet, cell phone, etc., or any other type of computing device.

In various implementations, the network coordination server(s) 112 can perform the throughput calculations and/or identify the parameter(s) in various ways. For example, the network coordination server(s) 112 can perform the throughput calculations and/or identify the parameter(s) in response to receiving one or more messages (e.g., one or more requests) from the computing device(s).

In some cases, the network coordination server(s) 112 can be triggered to perform the throughput calculations and/or identify the parameter(s). Triggering of the network coordination server(s) 112 to perform the throughput calculations and/or identify the parameter(s) can be automated. For instance, the network coordination server(s) 112 perform the throughput calculations and/or identify the parameter(s) in response to identifying one or more triggers, such as one or more scheduling triggers. In some examples, the scheduling trigger(s) may be associated with, and/or can identify, one or more calendar days, one or more times of the day, etc., or any combination thereof. The scheduling trigger(s) may be associated with, and/or can identify, the geographic location.

The network coordination server(s) 112 can perform the throughput calculations and/or identify the parameter(s) in response to identifying a current date and/or time matches a date and/or time identified by a requesting and/or scheduling trigger (e.g., a trigger resulting in transmission of a request by the computing device(s) and to the network coordination server(s) 112, for the average expected downlink speed to be calculated) (e.g., a trigger processed by the network coordination server(s) 112 and utilized to initiate the calculation(s) of the average expected downlink speed). For instance, the current date and/or time identified by the requesting and/or scheduling trigger may include a date and/or time within a predetermined number of days and/or predetermined amount of time, prior to the future event. In some cases, the predetermined number of days and/or the predetermined amount of time may be identified via user input to the network coordination server(s) 112, the cell site management server(s) 126, and/or the computing device(s). The predetermined number of days and/or the predetermined amount of time may be provided to the network coordination server(s) 112 based on the user input.

Alternatively or additionally, the network coordination server(s) 112, the cell site management server(s) 126, and/or the computing device(s) may perform automated identification of the predetermined number of days and/or the predetermined amount of time based on other events having a similarity of one or more characteristics and/or one or more types to the future event that is greater than a threshold similarity. A predetermined number of days and/or a predetermined amount of time associated with the other event may be automatically set as the predetermined number of days and/or a predetermined amount of time for the scheduling trigger utilized to trigger the performing of the throughput calculations and/or the identifying of the parameter(s) for the future event.

In some examples, the one or more triggers can include one or more repeating and/or periodic triggers. The repeating and/or periodic trigger(s) may be associated with, and/or can identify, one or more periods of time (e.g., a number of days, a number of hours, a number of minutes, etc., or any combination thereof), such as for an event that happens periodically (e.g., every month, every year, etc.). The repeating and/or periodic trigger(s) may be associated with, and/or can identify, the geographic location. The network coordination server(s) 112 can perform the throughput calculations and/or identify the parameter(s) in response to identifying a duration between a previous time (e.g., at which the throughput calculations were performed and/or the parameter(s) were identified for the geographic location 106) and a current time exceeds a period of time associated with a repeating and/or periodic trigger.

In some examples, any of the trigger(s) may be managed (e.g., identified, determined, generated, modified, deleted, etc., or any combination thereof) by the network coordination server(s) 112. In alternative or additional examples, any of the trigger(s) may be managed (e.g., identified, determined, generated, modified, deleted, etc., or any combination thereof) by the computing device(s).

In some cases, for instance with a trigger being managed by a computing device, the computing device can transmit the message with the trigger to the network coordination server(s) 112. Alternatively to receiving the scheduling trigger(s) with the scheduling information (e.g., the day, the time, etc.), the network coordination server(s) 112 may receive a scheduling trigger identifying the future event but omitting any scheduling information (e.g., the calendar date, the time, etc.) and/or without identifying the geographic location 106 associated with the future event. In those or other examples, the network coordination server(s) 112 can identify the scheduling information (e.g., by searching the database(s) and/or the geographic location 106, by exchanging one or more messages with the cell site management server(s) 126, the computing device(s), etc., or any combination thereof).

In response to the performing of the throughput calculations and/or the identifying of the parameter(s) being complete, the network coordination server(s) 112 can exchange one or more messages with the cell site management server(s) 126. In various examples, the network coordination server(s) 112 can, in response to identifying the throughput calculations being complete and/or the parameter(s) being identified, transmit a message to the cell site management server(s) 126. The message can include data (e.g., the parameter(s), such as the average expected downlink speed) based on the throughput calculations and/or the parameter(s).

In those or other examples, the network coordination server(s) 112 can, in response to the performing of the throughput calculations and/or the identifying of the parameter(s) being complete, store the data (e.g., the parameter(s), such as the average expected downlink speed). The data may be stored in the network coordination server(s) 112, the cell site management server(s) 126, the computing devices, or any combination thereof. In various instances, the network coordination server(s) 112 can store the data (e.g., the average expected downlink speed) in one or more databases, and/or cause the data to be stored by transmitting one or more queries (e.g., with the data) to the database(s). The database(s) can be managed by the network coordination server(s) 112, the cell site management server(s) 126, the computing devices, or any combination thereof.

In some examples, the cell site management server(s) 126 can perform one or more actions based on the message and/or the data (e.g., the parameter(s), such as the average expected downlink speed) received from the network coordination server(s) 112. For instance, the action(s) (e.g., some or all of which can be automated action(s)) can be performed based on the average expected downlink speed.

While the action(s) can be performed by the cell site management server(s) 126, as discussed above in the current disclosure, it is not limited thereto. In some examples, any of at least one of the action(s) can, alternatively or additionally, be performed by the network coordination server(s) 112. In those or other examples, any of at least one of the network coordination server(s) 112 and/or any of at least one of the cell site management server(s) 126 can be independent from, and/or integrated with, any of at least one of the network coordination server(s) 112 and/or any of at least one of the cell site management server(s) 126.

In some examples, the action(s) can be performed in response to calculating of the average expected downlink speed and by the network coordination server(s) 112. In those or other examples, the action(s) can include at least one of transmitting a response signal. In various cases, for instance with the average expected downlink speed being calculated in response to receiving a request from a computing device, the response signal, which can include the average expected downlink speed, can be transmitted to the computing device.

In those or other examples, the action(s) can include generating an event-related alarm. The event-related alarm can be transmitted to the computing device, which can output the event-related alarm. For example, one or more alarms can be generated and output, such as one or more audio alarms, one or more visual alarms, one or more haptic alarms, etc., or any combination thereof. The alarm(s) can be output by a user interface (UI) of any of at least one of the network coordination server(s) 112, a UI of any of at least one of the cell site management server(s) 126, and/or a UI of any of the computing device(s).

In those or other examples, the action(s) can include generating an event-related advisory alert (also referred to herein simply as “advisory” or “alert”). The generating of the alert can include performing an automated action, such as generating the alert identifying information to be used to place a number of cell sites at an event site (e.g., a venue) prior to the future event. In some examples, the alert can include identifiers of types of the cell sites.

In those or other examples, the action(s) can include generating a temporal-based and venue-specific cell site transport request query (also referred to herein as “temporal-based and venue-specific cell site transport query,” or simply as “query”). The query can be transmitted to the computing device, which can be utilized to output the query. The query may insert (e.g., cause insertion of) an entry in a database disabling at least one of automated cell site activation or remote cell site delivery. The query may be utilized to insert the entry based on a level of difficulty, danger, risk, practicality, etc., or a combination thereof, to cell site(s) (e.g., and/or equipment utilized for delivery therefor) associated with the at least one of automated cell site activation or remote cell site delivery identification (e.g., automatically identification) by the computing device being greater than a threshold.

The level of difficulty, danger, risk, practicality, etc., or a combination thereof to the site(s) and/or equipment utilized for delivery thereof, may be, for example, automatically determined by the cell site management servers 126. The entry may be accessed (e.g., by the computing device) and may invoke an alert associated with manual transport of a number of cell sites to a venue prior to the future event. The number of cell sites with which the alert is associated may be manually transported to the future event based on the alert. The manual transport may be performed in lieu of the automated cell site activation or the remote cell site delivery.

The action(s) can be automatically identified and/or generated so that the most beneficial action is utilized. Alternatively to disabling the at least one of the automated cell site activation or the remote cell site delivery, the reverse may be performed in some cases. For example, an action including the at least one of the automated cell site activation or the remote cell site delivery may be utilized in lieu of manual transportation of a cell site. The at least one of the automated cell site activation or the remote cell site delivery may be utilized in lieu of the manual transportation of a cell site based on a level of difficulty, danger, risk, practicality, etc., or a combination thereof, to person(s) associated with the manual transportation being greater than a threshold.

The level of difficulty, danger, risk, practicality, etc., or a combination thereof associated with the person(s) may be, for example, automatically determined by the cell site management servers 126. The level of difficulty, danger, risk, practicality, etc., or a combination thereof associated with the person(s) may be, for example, utilized to input a query and/or perform an alert in a similar way as for the level of difficulty, danger, risk, practicality, etc., or a combination thereof to the site, and/or equipment used for delivery thereof, as discuss above.

In those or other examples, the action(s) can include triggering temporal-based activation of a dormant cell site. The activation of the dormant cell site can include the dormant cell site being located at the geographic location 106, such as with the dormant cell site being one of the future potential UE(s) 104. For example, the dormant cell site can be one of the future potential UE(s) 104 being activated (e.g., automatically automated) at the geographic location 106 during the future event.

In those or other examples, the action(s) can include triggering temporal-based remote delivery of a portable cell site. For instance, the temporal-based remote delivery can include delivery of the portable cell site, such as a drone. In such an instance or another instance, the portable cell site can be one of the future potential cell site(s) 102. The delivery of the drone can be automated, with the drone flying to the geographic location 106 to be at the geographic location 106 during the future event.

In those or other examples, the action(s) can include establishing an individualized cell cite placement scheduling tag (also referred to herein as “tag”). The individualized cell cite placement scheduling tag can be utilized to schedule delivery of at least one of the future potential cell site(s) 102. The scheduled delivery can include manual delivery (or “manual transport”) (e.g., human-based, vehicle-based, robot-based, etc., or any combination thereof, delivery) of the at least one future potential cell site 102. The delivery can be scheduled, for example, based on the tag being transmitted to the computing device. The delivery can be scheduled and realized to place the future potential cell site(s) 102 at the geographic location 106 during the future event.

In some examples, a specific location within the geographic location 106 can be utilized for placing the future potential cell site(s) 102 via any of the action(s). One or more identifiers may be utilized for placing the future potential cell site(s) 102 at one or more smaller locations. The identifier(s) can be specified (e.g., requested, scheduled, ordered, etc.) via the action(s). In some examples, the smaller location(s) may be identified by map data (e.g., a route outlining a perimeter of a smaller location), one or more coordinates (e.g., GPS coordinates) associated with the smaller location and/or one or more points in the smaller location and/or the perimeter, etc.

In alternative or additional examples, the location(s) for the future potential cell site(s) 102 according to any of the action(s) can be specified (e.g., requested, scheduled, ordered, etc.) by the coordinate(s), and, possibly, an elevation, vertical distance, altitude etc., such as for any of at least one of the future potential cell site(s) 102 being a drone (e.g., a flying drone). By locating the drone in the air, range of signals utilized by the future potential UE(s) 104 can be extended in comparison to signals with other cell sites closer to the ground. Alternatively or additionally, type(s) of the future potential cell site(s) 102 specified (e.g., requested, scheduled, ordered, etc.) via any of the action(s) can include macro cells (or, cell towers), mini- and micro-cells, wireless routers, and/or any other types of cell sites. Alternatively or additionally, type(s) of the future potential cell site(s) 102 specified (e.g., requested, scheduled, ordered, etc.) via any of the action(s) can include wireless technologies (e.g., 5G, LTE, 3G, etc.) supported by the cell site(s).

The identifier(s) and/or the data identifying the geographic location 106 and/or any other location (e.g., smaller location) can be included in any other message(s) communicated by the network coordination server(s) 112, the cell site management server(s) 126, and/or the computing device(s) based on the calculation result(s). The identifier(s) and/or the data identifying the geographic location 106 and/or any other location (e.g., smaller location) can be included in any message(s) exchanged based on identification(s) (e.g., the cell site identifications and/or selection(s)) utilizing the calculation result(s).

In various examples, the action(s) can be utilized for removal of the future potential cell site(s) (e.g., the future potential cell site(s) 202, 204, and/or 206). The removal can be performed using the action(s) in similar ways as for, and/or utilizing similar action(s) as for, the placement of the future potential cell site(s).

In a hypothetical example, a user enters a request into a computing device and the request is communicated to the network coordination server(s) 112. The request includes a name of an event space and a date of a future event occurring at the space. The request indicates that the user would like to receive an expected downlink speed at the location during the future event.

In the hypothetical example, the network coordination server(s) 112 identify the geographic location 106 based on the name of the event space and access data (e.g., from the service provider server(s) and/or the network server(s)) associated with cell sites at the geographic location 106. The cell site data includes the technologies (e.g., frequency bands) used by the cell sites. The network coordination server(s) 112 determine how much bandwidth is available for each of the technologies, and a factor given to those bandwidths. The network coordination server(s) 112 a total available bandwidth for all of the available bandwidths. The network coordination server(s) 112 calculate an effective bandwidth for each of the technologies, and a total effective bandwidth for all of the effective bandwidths. The network coordination server(s) 112 calculate a predicted RRC per 5 MHz parameter based on a number of expected simultaneous users at the event space during the future, and based on the other calculation results. The network coordination server(s) 112 then calculate the average expected downlink speed (e.g., between 0-500 meters of the site/event space) using all of those calculation results. The network coordination server(s) 112 then transmit the average expected downlink speed back to the computing device, us the average expected downlink speed to take an action, or transmit the average expected downlink speed to network management servers, such as the cell site management server(s) 126.

In the hypothetical example, the network coordination server(s) 112, the cell site management server(s) 126, and/or the computing device(s) are used, based on the average expected downlink speed, to arrange for placement of future cell sites during the event. By placing the future cell sites, the average expected downlink speed can be maintained despite number of UE(s) increasing during the event.

While the future event may be used for determining the average expected downlink speed, as discussed above in the current disclosure, it is not limited thereto. In various cases, the future even may include any type of future event. For example, the future event may include a scheduled (e.g., a human scheduled) future event, such as a car race, a music concert, a sports game, a rally, a speech, an assembly, a celebration, a ceremony, a festival, any other type of future event (e.g., a future social event, a future political event, a future cultural event, a future religious event, a future industrial event, a future business event, a future themed event, etc.), or any combination thereof, for purposes of implementing any techniques as discussed herein.

Alternatively or additionally, for example, the future event may include a predicted (e.g., but not human scheduled) future event, such as an environmental occurrence predicted during a time period within a predetermined threshold of accuracy, a geological occurrence predicted during a time period within a predetermined threshold of accuracy, etc., and/or an astronomical occurrence (e.g., a solar eclipse) predicted during a time period within a predetermined threshold of accuracy. Alternatively or additionally, for example, the future event may include any other type of future non-human scheduled and/or caused event predicted during a time period within a predetermined threshold of accuracy, or any combination thereof, for purposes of implementing any techniques as discussed herein.

While analysis is performed in various ways and for various purposes with respect to the future event and using the phrase “during the future event,” as discussed above in the current disclosure, this language is used for simplicity and ease of explanation and is not intended to be limiting in any way. For example, any techniques as discussed herein may be implemented with the phrase “during the future event” being interpreted as any of various types of time frames corresponding to an occurrence of the future event, additionally or alternatively, to a time period coinciding with the future event. In such an example or another example, the phrase “during the future event” may be interpreted as a time period having a start time occurring at a start time of the future event, and/or an end time occurring at an end time of the future event; a time period having a start time occurring within a threshold time of a start time of the future event, and/or an end time occurring within a threshold time of an end time of the future event; any other type of time period corresponding to an occurrence of the future event, or any combination thereof.

While the capacity management components 114 are included in the network coordination server(s) 112, as discussed above in the current disclosure, it is not limited as such. In some examples, any of at least one of the capacity management components 114 (e.g., the available technologies component 116, the available bandwidths component 118, the estimated usage-related factors component 120, the average expected downlink speeds component 124, or any combination thereof) can be included in one, or a combination of any number, of the network coordination server(s) 112.

While the component(s) in the capacity management components 114, such as the available technologies component 116, the available bandwidths component 118, the estimated usage-related factors component 120, the average expected downlink speeds component 124, and/or the other component(s), may be separate, as discussed above in the current disclosure, it is not limited as such. In some examples, any combination of the available technologies component 116, the available bandwidths component 118, the estimated usage-related factors component 120, the average expected downlink speeds component 124, and/or the other component(s) may be integrated with each another.

While the terms “future potential UE(s),” future potential cell site(s),” and “future event” are used for simplicity of explanation, as discussed throughout the current disclosure, it is not limited thereto. For example, the future potential UE(s) represent current UE(s) present at the geographic location 106 during the future event, which becomes an event at the time at which the event occurs; and, similarly, the future potential cell site(s) represent cell site(s) as they are placed at the geographic location.

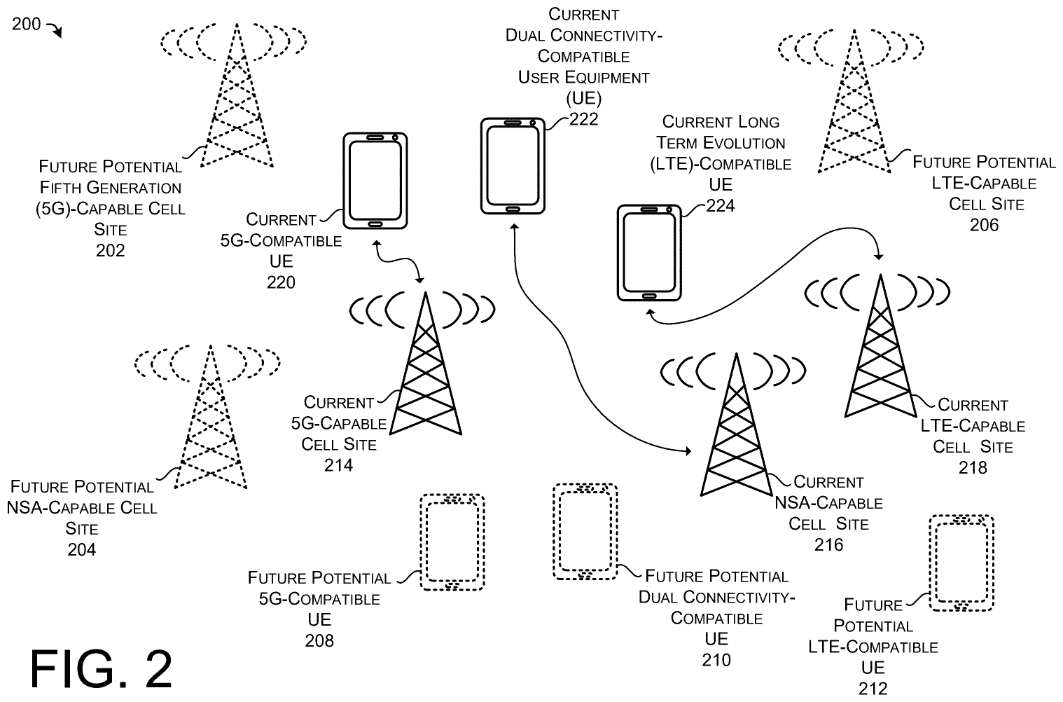

FIG. 2 schematically illustrates an example environment 200 for potential RRC UE population-based and predicted available spectrum-based future site capacity calculations and network management, for a network with various types of cell sites, including NSA-capable cell sites. In some examples, a portion (e.g., a partial portion or an entire portion) of the environment 200 may be implemented as a portion (e.g., a partial portion or an entire portion) of the environment 100, as discussed above with reference to FIG. 1.

In some examples, the environment 200 can include one or more future potential 5G cell sites 202, one or more future potential NSA-capable cell sites 204, and one or more future potential LTE-capable cell sites 206, also referred to herein as future potential cell site(s) 202, 204, and/or 206. In those or other examples, the future potential 5G cell site(s) 202, the future potential NSA-capable cell site(s) 204, and/or the future potential LTE-capable cell site(s) 206 may be implemented as the future potential cell site(s) 102, as discussed above with reference to FIG. 1.

In some examples, the environment 200 can include one or more future potential 5G-compatible UEs 208, one or more future potential dual connectivity-compatible UEs 210, and one or more future potential LTE-compatible UEs 212, also referred to herein as future potential UE(s) 208, 210, and/or 212. In those or other examples, the future potential 5G-compatible UE(s) 208, the future potential dual connectivity-compatible UE(s) 210, and/or the future potential LTE-compatible UE(s) 212 may be implemented as the future potential UE(s) 104, as discussed above with reference to FIG. 1.

In some examples, the environment 200 can include one or more current 5G-capable cell sites 214, one or more current NSA-capable cell sites 216, and one or more current LTE-capable cell sites 218, also referred to herein as current cell site(s) 214, 216, and/or 218. In those or other examples, the current 5G NSA-capable cell site(s) 214, the current NSA-capable cell site(s) 216, and/or the current LTE-capable cell site(s) 218 may be implemented as the current cell site(s) 108, as discussed above with reference to FIG. 1. In various examples, any of the current UE(s) 220, 222, and/or 224 may also be any of the future potential UE(s) 208, 210, 212, which can also include other future potential UE(s).

In some examples, the environment 200 can include one or more current 5G-compatible UEs 220, one or more current dual connectivity-compatible UEs 222, and one or more current LTE-compatible UEs 224, also referred to herein as current UE(s) 220, 222, and/or 224. In those or other examples, the current 5G-compatible UE(s) 220, the current dual connectivity-compatible UE(s) 222, and/or the current LTE-compatible UE(s) 224 may be implemented as the current UE(s) 110, as discussed above with reference to FIG. 1. At least one of the current 5G-compatible UE(s) 220, at least one of the current dual connectivity-compatible UE(s) 222, and/or at least one of the current LTE-compatible UE(s) 224 may be communicatively connected to at least one of the current 5G-capable cell site(s) 214, at least one of the current NSA-capable cell site(s) 216, and/or at least one of the current LTE-capable cell site(s) 218, respectively.

In some implementations, any of the future potential NSA-capable cell site(s) 204 is part of a future potential NSA architecture. In some implementations, any of the current NSA-capable cell site(s) 216 is part of a current NSA architecture. For instance, any of the future potential 5G NSA-capable cell site(s) 204 and/or any of the current NSA-capable cell site(s) 216 may include both a 4G transceiver (e.g., an eNodeB) by which an LTE radio link(s) is established, and a 5G transceiver (e.g., a gNodeB) by which an NR radio link(s) is established. In some cases, functions (e.g., transmission intervals, transmission power, etc.) of the 4G transceiver and the 5G transceiver are coordinated by the future potential cell site(s) 102 and/or the current cell site(s) 108. In some examples, the future potential cell site(s) 102 and/or any of the current cell site(s) 108 may include functionality to function as a Standalone (SA) architecture.

In some examples, the environment 200 can include one or more servers, such as the network coordination server(s) 112 and/or the cell site management server(s) 126, as discussed above with reference to FIG. 1. In various instances, the network coordination server(s) 112 and/or the cell site management server(s) 126 can be utilized to identify the parameter(s), perform the calculation(s), perform the action(s), and/or performing any other functions, as discussed above with reference to FIG. 1, and taking into account types (e.g., capabilities) of the current cell site(s) 214, 216, and/or 218, and/or types (e.g., compatibility(ies)) of the future potential UE(s) 208, 210, and/or 212.

In various instances, the action(s) associated with the future potential sell site(s) 202, 204, and/or 206, and/or any number of other future potential sell cites(s) of the same, or different, types, can be performed utilizing the result(s) of the calculation(s), and based on identifying one or more corresponding types of the current cell site(s) 214, 216, and/or 218, and/or one or more corresponding predicted types of the future potential UE(s) (e.g., the future potential UE(s) 208, 210, and/or 212). In some examples, the corresponding predicted type(s) of the future potential UE(s) can be identified automatically by the cell site management server(s) 126. Automated identifying of the corresponding predicted type(s) of the future potential UE(s) can be based on historical information associated with the geographic location 106, the future event, one or more geographic areas having a similarity score associated with the geographic location 106 that is greater than a threshold similarity score, one or more events (e.g., one or more past events, one or more current events, one or more other future events, or any combination thereof) having a similarity score associated with the geographic location 106 that is greater than a threshold similarity score, one or more other types of information, or any combination thereof. The automated identifying can be performed by the network coordination server(s) 112, the cell site management server(s) 126, and/or the computing devices.

In those or other examples, automated identifying of the corresponding predicted type(s) of the future potential UE(s) can be based on extrapolation of one or more corresponding types of the current UE(s). The extrapolation may be performed using the historical information, or, possibly, not using the historical information.

In some examples, the corresponding predicted type(s) of any of the future potential UE(s) can be identified based on user input to the network coordination server(s) 112, the cell site management server(s) 126, and/or the computing devices. For example, user input via one or more selections of a user received by the network coordination server(s) 112, the cell site management server(s) 126, and/or the computing devices may identify the corresponding predicted type(s) of the future potential UE(s).

Any of action(s) associated with the future potential sell site(s) 202, 204, and/or 206, and/or any number of other future potential sell cites(s) of the same, or different, types, can be performed based on the corresponding predicted type(s) of the future potential UE(s). The action(s) associated with the future potential sell site(s) 202, 204, and/or 206, and/or any number of other future potential sell cites(s) can be performed as automated action(s) and/or based on user input. In some examples, for instance with the action(s) being performed based on user input, the action(s) may be performed based on user input via one or more selections of a user received by the network coordination server(s) 112, the cell site management server(s) 126, and/or the computing devices, the selection(s) identifying the corresponding future potential sell cites(s), and/or the corresponding predicted type(s) of the future potential sell cites(s).

In various examples, the action(s) can include exchanging, between any combinations of the network coordination server(s) 112, the cell site management server(s) 126, and/or the computing devices, one or more messages with one or more identifiers of the corresponding future potential sell cites(s), and/or one or more identifiers of the corresponding predicted type(s) of the future potential sell cites(s). Any of the server(s)/device(s) (e.g., the network coordination server(s) 112, the cell site management server(s) 126, and/or the computing devices) identifying the corresponding future potential sell cites(s), and/or the corresponding predicted type(s) of the future potential sell cites(s), based on the calculation result(s), can transmit a message, with the identifier(s) of the corresponding future potential sell cites(s), and/or the identifier(s) of the corresponding predicted type(s) of the future potential sell cites(s), to any of the other server(s)/device(s).

Any of the action(s) can be performed utilizing the calculation-oriented identifiers (e.g., the identifier(s) of the corresponding future potential sell cites(s), and/or the identifier(s) of the corresponding predicted type(s) of the future potential sell cites(s)). For example, the calculation-oriented identifiers can be stored by the server(s)/device(s), and/or in the database(s), as discussed above with reference to FIG. 1. The calculation-oriented identifiers can be utilized to identify a type of alarm being generated, included in an advisory alert (e.g., identifying a cell stie to be placed, and, possibly, a type of the sell cite) output by the server(s)/device(s), utilized to generate a unique query (e.g., a query to request information) associated with a specific type of sell cite, utilized to generate a dormant cell site of a specific type, utilized to trigger temporal-based remote delivery of a portable cell site of a specific type, utilized to establish an individualized cell cite placement scheduling tag for a cell site of a specific type and/or for a specific location (e.g., within the geographic location 106), utilized to schedule delivery of a cell site of a specific type for a specific location (e.g., within the geographic location 106), as discussed above with reference to FIG. 1, and/or for any other types of actions.

As a hypothetical example, data can be gathered regarding types of cell sites at a site, such as an event space, and types of UEs that are predicted to be at the space during a future event. To ensure that downlink speeds for the UEs during the event are maintained at acceptable levels, the average expected downlink speed can be calculated. The average expected downlink speed can be used to identify how many other cell sites need to be placed at the site during the event, what types of cell sites are most likely to provide the best service to the UEs based on predictions of numbers of UEs of specific types, and where the cell sites should be placed for ensuring optimal downlink speeds.

In the hypothetical example, the cell sites (e.g., future potential cell sites) can be placed automatically, such as by drones. Alternatively or additionally, operators of the computing devices can request the cell sites to be carried by vehicles and personnel to the site so that the cell sites are in position during the event. The scheduling of the cell sites can include placement and removal of the cell sites. The cell site can be placed over time according to changes in types of UEs. For example, as more and more UEs having 5G capabilities/compatibilities are being used, relatively greater numbers of cells cites can be placed at the event spaces than might have been placed in the past when there were larger numbers of non-5G compatible UEs being used.

While the environment 200 includes the future potential cell site(s) 202, 204, and/or 206, as discussed above in the current disclosure, it is not limited as such. In some examples, any of the future potential cell site(s) 202, 204, and/or 206 can include any physical characteristics (e.g., structure) and/or functional capabilities of any other of the future potential cell site(s) 202, 204, and/or 206, and/or any other types of cell sites.

While the environment 200 includes the future potential UE(s) 208, 210, and/or 212, as discussed above in the current disclosure, it is not limited as such. In some examples, any of the future potential UE(s) 208, 210, and/or 212 can include any physical characteristics (e.g., structure) and/or functional capabilities of any other of the future potential UE(s) 208, 210, and/or 212, and/or any other types of UEs.

While the environment 200 includes the current cell site(s) 214, 216, and/or 218, as discussed above in the current disclosure, it is not limited as such. In some examples, any of the current cell site(s) 214, 216, and/or 218 can include any physical characteristics (e.g., structure) and/or functional capabilities of any other of the current cell site(s) 214, 216, and/or 218, and/or any other types of cell sites.

While the environment 200 includes the current UE(s) 220, 222, and/or 224, as discussed above in the current disclosure, it is not limited as such. In some examples, any of the current UE(s) 220, 222, and/or 224 can include any physical characteristics (e.g., structure) and/or functional capabilities of any other of the current UE(s) 220, 222, and/or 224, and/or any other types of UEs.

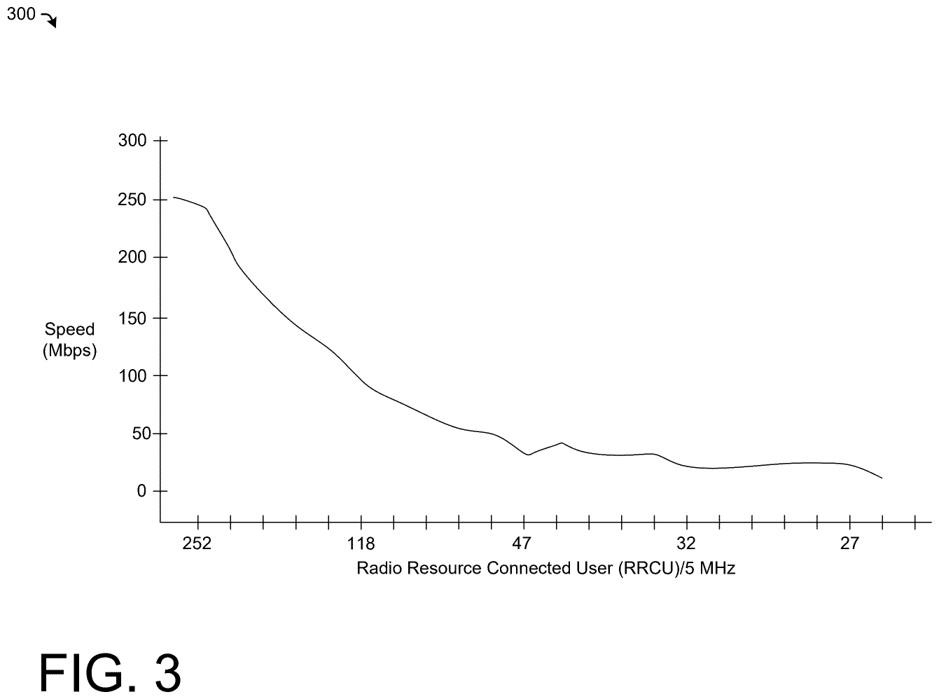

FIG. 3 is a diagram illustrating an example graph 300 representing a relationship between RRCU/5 MHz parameters and downlink speeds. For example, an x-axis of the graph 300 can represent the RRCU/5 MHz parameters, and a y-axis of the graph 300 can represent the downlink speeds, in Mbps.

In some instances, for example, an RRCU/5 MHz parameter of 8.62069 RRC/5 MHz may correspond to an average expected downlink speed of 50-75 Mbps. By identifying the RRCU/5 MHz parameter utilizing the calculation(s), as discussed above with reference to FIGS. 1 and 2, the average expected downlink speed can be identified as 50-75 Mbps, as shown in the graph 300. The graph 300 can be identified as including average expected downlink speeds associated with any frequency band (e.g., the 5G 2500 MHz band) (e.g., an N25 layer) being utilized for the throughput calculation (e.g., the average expected downlink speed calculation).

As depicted in FIG. 3, relatively fewer UEs in a geographic area results in relatively greater speeds, such as based on an RRC/5 MHz parameter (e.g., a parameter of 8.62069 RRCUs/5 MHz, identified via measured values received from UE(s), such as the current UE(s) 110). For instance, for 1 UE that is an RRCU in the network, the UE may have a speed of ˜250 Mbps. In such an instance or another instance, for 2 UEs that are RRCUs in the network, the UEs may have speeds of ˜190 Mbps. In such an instance or another instance, for 8 UEs that are RRCUs in the network, the UEs may have speeds of ˜50-60 Mbps.

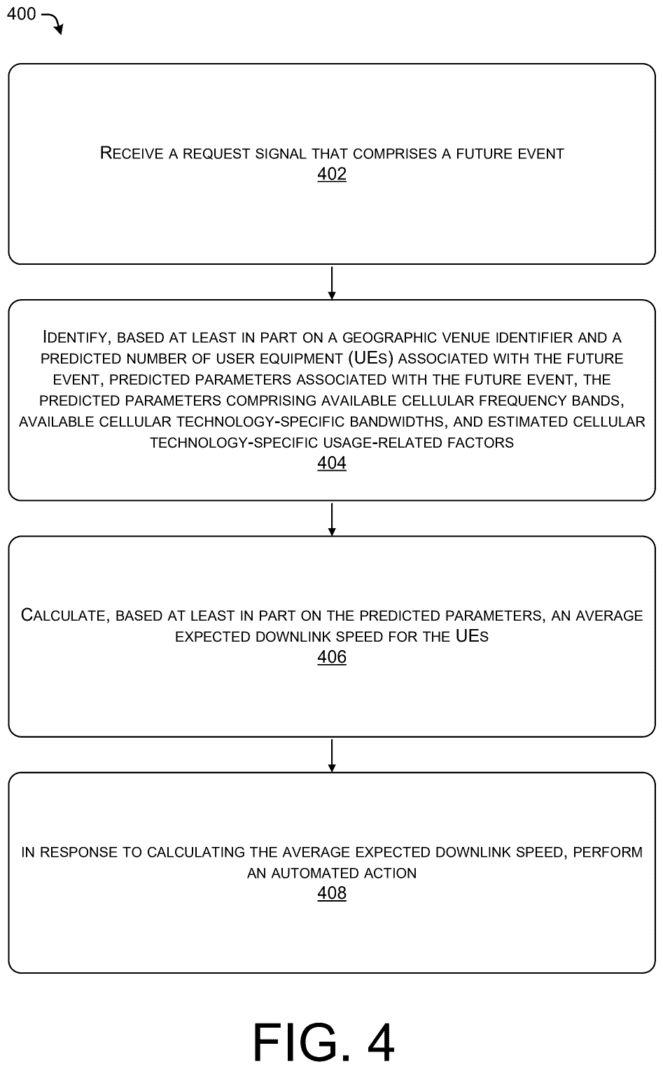

FIG. 4 illustrates an example process 400 for potential RRC UE population-based and predicted available spectrum-based future site capacity calculations and network management. The process 400 may be utilized for the calculation(s) to identify the average expected downlink speed(s), as discussed above with reference to FIGS. 1-3.

At operation 402, the process 400 can include receiving a request signal that is indicative of a future event. The signal can be received by a network coordination server 112 and from a computing device. The signal can include a message that is transmitted by the computing device and to the network coordination server 112. The signal can include an identifier (e.g., name, one or more other identifiers of any type), and/or a link associated with the future event. The link can include computing code being used to access the identifier(s) and/or information identifying the event, etc.

Alternatively or additionally, the signal can include one or more identifiers and/or a link associated with a geographic location associated with the future event. The link can include computing code being used to access the identifier(s) and/or information identifying the geographic location, etc. Alternatively or additionally, the signal can include, possibly, a date/time of the future event. Alternatively or additionally, the signal can include, possibly, identifiers (e.g., GPS coordinates) associated with a location of the future event.

At operation 404, the process can include identifying, based at least in part on a geographic venue identifier and a predicted number of user equipment (UEs) (e.g., the future potential UE(s) 104) associated with the future event, predicted parameters associated with the future event. The geographic venue identifier may be accessed via the signal. The predicted parameters can include available cellular frequency bands, determined by an available technologies component 116. The predicted parameters can include available cellular technology-specific bandwidths, determined by an available bandwidths component 118. The predicted parameters can include estimated cellular technology-specific usage-related factors, determined by an estimated usage-related factors component 120.

In some examples, the predicted parameters can include effective bandwidths. The effective bandwidths can be determined by an effective bandwidths component 122.

At operation 406, the process can include calculating, based at least in part on the predicted parameters, an average expected downlink speed for the UEs. The average expected downlink speed can be calculated by an average expected downlink speeds component 124. The average expected downlink speed can be calculated based on the available cellular frequency bands, the available cellular technology-specific bandwidths, the estimated cellular technology-specific usage-related factors, and the effective bandwidths.

At operation 408, the process can include, in response to calculating the average expected downlink speed, performing an automated action. Performing the automated action can include at least one of transmitting a response signal, generating an event-related alarm, generating a temporal-based and venue-specific cell site transport query, triggering temporal-based activation of a dormant cell site, triggering temporal-based remote delivery of a portable cell site, or establishing an individualized cell cite placement scheduling tag. In some examples, the automated action can be performed by the cell site management server(s) 126.

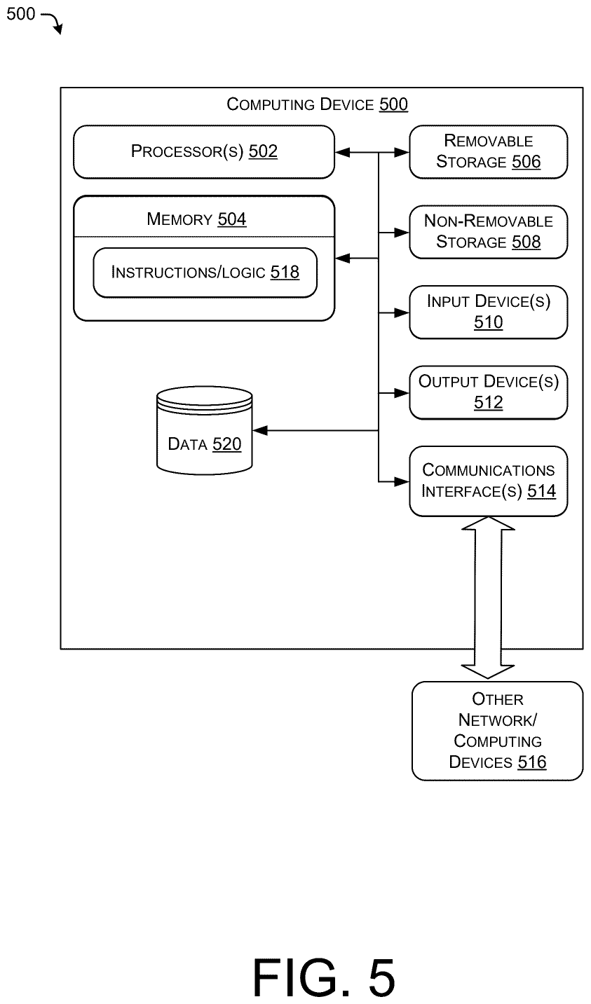

FIG. 5 illustrates is a block diagram of a server computer 500 architecture, in accordance with some examples of the present disclosure. The server computer 500 may be representative of an individual server (e.g., a server of the environment 100, such as any of the network coordination servers, any of the network management servers, etc., as discussed above with reference to FIG. 1) associated with the cellular network.

As shown, the server computer 500 may include one or more processors 502 and one or more forms of computer-readable memory 504. The server computer 500 may also include additional storage devices. Such additional storage may include removable storage 506 and/or non-removable storage 508.

The server computer 500 may further include input devices 510 (e.g., a touch screen, keypad, keyboard, mouse, pointer, microphone, etc.) and output devices 512 (e.g., a display, printer, speaker, etc.) communicatively coupled to the processor(s) 502 and the computer-readable memory 504. The server computer 500 may further include communications interface(s) 514 that allow the server computer 500 to communicate with other computing devices 516 (e.g., other nodes, a UE(s), etc.) such as via a network. The communications interface(s) 514 may facilitate transmitting and receiving wired and/or wireless signals over any suitable communications/data technology, standard, or protocol, as described herein.

In various embodiments, the computer-readable memory 504 comprises non-transitory computer-readable memory 504 that generally includes both volatile memory and non-volatile memory (e.g., random access memory (RAM), read-only memory (ROM), erasable programmable read-only memory (EEPROM), Flash Memory, miniature hard drive, memory card, optical storage, magnetic cassettes, magnetic tape, magnetic disk storage or other magnetic storage devices, or any other medium). The computer-readable memory 504 may also be described as computer storage media and may include volatile and nonvolatile, removable and non-removable media implemented in any method or technology for storage of information, such as computer readable instructions, data structures, program components, or other data. Computer-readable memory 504, removable storage 506 and non-removable storage 508 are all examples of non-transitory computer-readable storage media. Computer-readable storage media include, but are not limited to, RAM, ROM, EEPROM, flash memory or other memory technology, compact disc read-only memory (CD-ROM), digital versatile disks (DVD) or other optical storage, magnetic cassettes, magnetic tape, magnetic disk storage or other magnetic storage devices, or any other medium which can be used to store the desired information and which can be accessed by the server computer 500. Any such computer-readable storage media may be part of the server computer 500.

The memory 504 can include logic 518 (i.e., computer-executable instructions that, when executed, by the processor(s) 502, perform the various acts and/or processes disclosed herein) to implement synchronization of subscriber data, according to various examples as discussed herein. For example, the logic 518 is configured to carry out signaling and/or communications associated with the future potential cell site(s) 102, the future potential UE(s) 104, the current cell site(s) 108, and/or the current UE(s) 110. The memory 504 can further be used to store data 520, which may be used to implement synchronization of subscriber data, as discussed herein. In one example, the data 520 may include network information (e.g., the parameter(s), the calculate result(s), data utilized for the action(s), any other data associate with the environments 100 and 200, as discussed above with reference to FIGS. 1-4).

The environment and individual elements described herein may of course include many other logical, programmatic, and physical components, of which those shown in the accompanying figures are merely examples that are related to the discussion herein.

The various techniques described herein are assumed in the given examples to be implemented in the general context of computer-executable instructions or software, such as program modules, that are stored in computer-readable storage and executed by the processor(s) of one or more computers or other devices such as those illustrated in the figures. Generally, program modules include routines, programs, objects, components, data structures, etc., and define operating logic for performing particular tasks or implement particular abstract data types.

Other architectures can be used to implement the described functionality, and are intended to be within the scope of this disclosure. Furthermore, although specific distributions of responsibilities are defined above for purposes of discussion, the various functions and responsibilities might be distributed and divided in different ways, depending on circumstances.

Similarly, software can be stored and distributed in various ways and using different means, and the software storage and execution configurations described above can be varied in many different ways. Thus, software implementing the techniques described above can be distributed on various types of computer-readable media, not limited to the forms of memory that are specifically described.

What is claimed is:

1. A system comprising:
at least one processor; and
non-transitory memory storing instructions that, when executed by the at least one processor, cause the at least one processor to perform operations comprising:
receiving a request signal that is indicative of a future event;
identifying, based at least in part on a geographic venue identifier and potential user equipment (UEs) associated with the future event, predicted parameters associated with the future event, the predicted parameters comprising available cellular frequency bands, available cellular technology-specific bandwidths, and estimated cellular technology-specific usage-related factors;
calculating, based at least in part on the predicted parameters, an average expected downlink speed for the potential UEs; and
in response to calculating the average expected downlink speed, performing an automated action including at least one of transmitting a response signal, generating an event-related alarm, generating a temporal-based and venue-specific cell site transport request query, triggering temporal-based activation of a dormant cell site, triggering temporal-based remote delivery of a portable cell site, or establishing an individualized cell cite placement scheduling tag.

2. The system of claim 1, wherein calculating the average expected downlink speed includes:
calculating, via analysis of the potential UEs, a number of predicted radio resource connected (RRC) UEs per five megahertz (MHz) based at least in part on the available cellular frequency bands, the available cellular technology-specific bandwidths, and the estimated cellular technology-specific usage-related factors; and
calculating the average expected downlink speed based at least in part on the number of predicted RRC UEs per five MHz.

3. The system of claim 1, wherein the calculating of the average expected downlink speed is based at least in part on a number of the potential UEs expected to be simultaneously connected, during the future event, to a network of a service provider.

4. The system of claim 1, wherein the available cellular frequency bands are associated with a network of a service provider to which the potential UEs are expected to be connected during the future event.

5. The system of claim 1, wherein calculating the average expected downlink speed includes multiplying individual available cellular technology-specific bandwidths of the available cellular technology-specific bandwidths by corresponding ones of the estimated cellular technology-specific usage-related factors.

6. The system of claim 1, wherein performing the automated action includes at least one of the transmitting the response signal, the generating of the event-related alarm, or the generating of the temporal-based and venue-specific cell site transport request query.

7. The system of claim 1, wherein performing the automated action includes generating an event-related advisory alert, the event-related advisory alert identifying information to be used to place a number of cell sites at a venue prior to the future event.

8. The system of claim 1, wherein the temporal-based and venue-specific cell site transport request query inserts an entry in a database disabling at least one of automated cell site activation or remote cell site delivery, the entry being accessed and invoking an alert associated with manual transport of a number of cell sites to a venue prior to the future event.

9. The system of claim 1, wherein performing the automated action includes at least one of the triggering of the temporal-based activation of the dormant cell site, the triggering of the temporal-based remote delivery of the portable cell site, or the establishing of the individualized cell cite placement scheduling tag.

10. A network coordination server, comprising:
one or more processors; and
non-transitory memory storing computer-executable instructions that, when executed by the one or more processors, cause the one or more processors to perform operations comprising:
receiving a request signal that is indicative of a future event;
identifying, based at least in part on a geographic venue identifier and a predicted number of user equipment (UEs) associated with the future event, predicted parameters associated with the future event, the predicted parameters comprising available cellular frequency bands, available bandwidths, and estimated usage-related factors;
calculating, based at least in part on the predicted parameters, an expected downlink speed for the UEs; and
in response to calculating the expected downlink speed, transmitting a message to a network management server, the network management server performing an automated action.

11. The network coordination server of claim 10, wherein calculating the expected downlink speed includes:
calculating, via analysis of the UEs, a number of predicted radio resource connected (RRC) UEs per five megahertz (MHz) based at least in part on the available cellular frequency bands, the available bandwidths, and the estimated usage-related factors; and
calculating the expected downlink speed based at least in part on the number of predicted RRC UEs per five MHz.

12. The network coordination server of claim 10, wherein performing the automated action includes at least one of transmitting a response signal, generating an event-related alarm, or generating a temporal-based and venue-specific cell site transport query.

13. The network coordination server of claim 10, wherein the available cellular frequency bands are associated with a network of a service provider to which the UEs are expected to be connected during the future event.

14. The network coordination server of claim 10, wherein calculating the expected downlink speed includes multiplying individual available bandwidths of the available bandwidths by corresponding ones of the estimated usage-related factors.

15. The network coordination server of claim 10, wherein performing the automated action includes at least one of triggering temporal-based activation of a dormant cell site, triggering temporal-based remote delivery of a portable cell site, or establishing an individualized cell cite placement scheduling tag.

16. The network coordination server of claim 10, wherein performing the automated action includes generating a temporal-based and venue-specific cell site transport query, and
wherein the temporal-based and venue-specific cell site transport query inserts an entry in a database disabling at least one of automated cell site activation or remote cell site delivery, the entry being accessed and invoking an alert associated with manual transport of a number of cell sites to the venue prior to the future event.

17. A method comprising:
receiving a request signal that is indicative of a future event;
identifying, based at least in part on a geographic venue identifier and a predicted number of user equipment (UEs) associated with the future event, predicted parameters associated with the future event, the predicted parameters comprising available cellular frequency bands, available bandwidths, and estimated usage-related factors;
calculating, based at least in part on the predicted parameters, an expected downlink speed for the UEs; and
in response to calculating the expected downlink speed, performing an automated action.

18. The method of claim 17, wherein calculating the expected downlink speed includes:
calculating, via analysis of the UEs, a number of predicted radio resource connected (RRC) UEs per five megahertz (MHz) based at least in part on the available cellular frequency bands, the available bandwidths, and the estimated usage-related factors; and
calculating the expected downlink speed based at least in part on the number of predicted RRC UEs per five MHz.

19. The method of claim 17, wherein calculating the expected downlink speed is based at least in part on a number of the UEs expected to be simultaneously connected, during the future event, to a network of a service provider.

20. The method of claim 17, the available cellular frequency bands being associated with a network of a service provider to which the UEs are expected to be connected during the future event, wherein calculating the expected downlink speed comprises calculating the expected downlink speed based at least in part on, from among the available cellular frequency bands, at least one of a long term evolution (LTE) 600 megahertz (MHz) frequency band, an LTE 700 MHz frequency band, an LTE 2100 MHz frequency band, an LTE 1900 MHz frequency band, a fifth generation (5G) 1900 MHz frequency band, a 5G 2500 MHz frequency band, a 5G 39 gigahertz (GHz) frequency band, or a 5G 77 GHz frequency band.
